(19) United States
(12) Patent Application Publication
(10) Pub. No.: US 2025/0015280 A1
(43) Pub. Date: Jan. 9, 2025

(54) NEGATIVE ELECTRODE AND ZINC SECONDARY BATTERY

(71) Applicant: NGK INSULATORS, LTD., Nagoya-shi (JP)

(72) Inventors: Ryujiro NAGASAKA, Nagoya-city (JP); Sota SHIMIZU, Nagoya-city (JP); Toshiki HIRAIWA, Iwakura-city (JP)

(21) Appl. No.: 18/890,820

(22) Filed: Sep. 20, 2024

Related U.S. Application Data
(63) Continuation of application No. PCT/JP2022/040190, filed on Oct. 27, 2022.

(30) Foreign Application Priority Data
Mar. 29, 2022 (JP) 2022-053909

(51) Int. Cl. H01M 4/48; H01M 4/02; H01M 4/131; H01M 4/38; H01M 4/62; H01M 10/054; H01M 50/431

(52) U.S. Cl. CPC H01M 4/48; H01M 4/131; H01M 4/38; H01M 4/623; H01M 10/054; H01M 50/431; H01M 2004/021; H01M 2004/027; H01M 2004/028

(57) ABSTRACT

Provided is a negative electrode for use in a zinc secondary battery, including a negative electrode active material containing ZnO particles and Zn particles, and a binder that is a mixture of binder particles composed of a binder resin and binder fibers composed of the binder resin, in which, in an image analysis of the negative electrode, an average fiber diameter of the binder fibers is 0.05 to 0.17 μm, and a fiberization ratio, which is a ratio of an area of the binder fibers to the total area of the binder particles and the binder fibers, is 20 to 70%.

### CROSS-REFERENCE TO RELATED APPLICATIONS

This application is a continuation application of PCT/JP2022/040190 filed Oct. 27, 2022, which claims priority to Japanese Patent Application No. 2022-053909 filed Mar. 29, 2022, the entire contents all of which are incorporated herein by reference.

### BACKGROUND OF THE INVENTION

### 1. Field of the Invention

The present invention relates to a negative electrode and a zinc secondary battery.

### 2. Description of the Related Art

In zinc secondary batteries such as nickel-zinc secondary batteries, air-zinc secondary batteries, etc., metallic zinc precipitates from a negative electrode in the form of dendrites upon charging, and penetrates into voids of a separator such as a nonwoven fabric and reaches a positive electrode, which is known to result in bringing about short-circuiting. The short circuit due to such zinc dendrites shortens the life in repeated charge/discharge cycles.

In order to deal with the above issues, batteries comprising layered double hydroxide (LDH) separators that prevent penetration of zinc dendrites while selectively permeating hydroxide ions, have been proposed. For example, Patent Literature 1 (WO2013/118561) discloses that an LDH separator is provided between a positive electrode and a negative electrode in a nickel-zinc secondary battery. Moreover, Patent Literature 2 (WO2016/076047) discloses a separator structure comprising an LDH separator fitted or joined to a resin outer frame, and discloses that the LDH separator has a high density to the degree that it has gas impermeability and/or water impermeability. Moreover, this literature also discloses that the LDH separator can be composited with porous substrates. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to a porous substrate and subjecting the porous substrate to hydrothermal treatment in an aqueous solution of raw materials to form the LDH dense membrane on the surface of the porous substrate.

By the way, another factor that shortens the life of a zinc secondary battery includes a morphological change of zinc which is a negative electrode active material. More specifically, as zinc repeatedly dissolves and precipitates due to repeated charge and discharge, the negative electrode changes its morphology, causing high resistance due to clogging of pores, a decrease in a charge active material due to accumulation of isolated zinc, and the like, which results in difficulty in charge and discharge. In order to address this problem, Patent Literature 4 (WO2020/049902) proposes using as a negative electrode, a combination of ZnO particles and at least two selected from the group consisting of (i) metal Zn particles with a predetermined particle size, (ii) a predetermined metal element, and (iii) a binder resin having a hydroxyl group. According to this negative electrode, it is inhibited from being deteriorated due to repeated charge/discharge cycles to improve its durability in a zinc secondary battery, thereby enabling prolongation of a cycle life.

Moreover, Patent Literature 5 (JP6190101B) discloses a negative electrode mixture containing a negative electrode active material such as metallic Zn and ZnO, a polymer such as an aromatic group-containing polymer, an ether group-containing polymer, or a hydroxyl group-containing polymer, and a conductive aid that is a compound of elements such as B, Ba, Bi, Br, Ca, Cd, Ce, Cl, F, Ga, Hg, In, La, and Mn, which is suitable for forming storage batteries that exhibit battery performance such as high cycle characteristics, rate characteristics, and coulomb efficiency, while inhibiting morphological changes of an electrode active material, such as shape change and dendrites of the electrode active material, as well as dissolution, corrosion, and formation of passive state, of the electrode active material.

### CITATION LIST

### Patent Literature

Patent Literature 1: WO2013/118561
Patent Literature 2: WO2016/076047
Patent Literature 3: WO2016/067884
Patent Literature 4: WO2020/049902
Patent Literature 5: JP6190101B

### SUMMARY OF THE INVENTION

As disclosed in Patent Literatures 4 and 5, various attempts have been proposed to address reduction of cycle characteristics accompanying a morphological change of the zinc negative electrode, but requiring further improvement of cycle characteristics.

The present inventors have recently found that a cycle life of a zinc secondary battery can be prolonged by fiberizing a binder added to a negative electrode at a predetermined proportion and by controlling the average fiber diameter of the fiberized binder within a predetermined range.

Therefore, an object of the present invention is to provide a negative electrode capable of prolonging the cycle life of a zinc secondary battery.

The present invention provides the following aspects:

### [Aspect 1]

A negative electrode for use in a zinc secondary battery, comprising:
a negative electrode active material comprising ZnO particles and Zn particles, and
a binder that is a mixture of binder particles composed of a binder resin and binder fibers composed of the binder resin,
wherein, in an image analysis of the negative electrode, an average fiber diameter of the binder fibers is 0.05 to 0.17 μm, and a fiberization ratio, which is a ratio of an area of the binder fibers to the total area of the binder particles and the binder fibers, is 20 to 70%.

### [Aspect 2]

The negative electrode according to aspect 1, wherein the content of the binder fibers is 0.05 to 2 parts by weight, based on the content of ZnO particles being 100 parts by weight.

### [Aspect 3]

The negative electrode according to aspect 1 or 2, wherein the binder resin is at least one selected from the group consisting of polytetrafluoroethylene (PTFE), polyvinylidene fluoride (PVDF), and a cellulose resin.

### [Aspect 4]

The negative electrode according to any one of aspects 1 to 3, comprising the Zn particles in an amount of 1.0 to 87.5 parts by weight, based on the content of the ZnO particles being 100 parts by weight.

### [Aspect 5]

The negative electrode according to any one of aspects 1 to 4, further comprising one or more metal elements selected from In and Bi.

### [Aspect 6]

The negative electrode according to any one of aspects 1 to 5, wherein the negative electrode is a sheet-like pressed product.

### [Aspect 7]

A zinc secondary battery, comprising:
a positive electrode,
the negative electrode according to any one of aspects 1 to 6,
a separator separating the positive electrode from the negative electrode so as to be capable of conducting hydroxide ions therethrough, and
an electrolytic solution.

### [Aspect 8]

The zinc secondary battery according to aspect 7, wherein the separator is an LDH separator comprising a layered double hydroxide (LDH) and/or an LDH-like compound.

### [Aspect 9]

The zinc secondary battery according to aspect 8, wherein the LDH separator is composited with a porous substrate.

### [Aspect 10]

The zinc secondary battery according to any one of aspects 7 to 9, wherein the positive electrode comprises nickel hydroxide and/or nickel oxyhydroxide, whereby the zinc secondary battery forms a nickel-zinc secondary battery.

### [Aspect 11]

The zinc secondary battery according to any one of aspects 7 to 9, wherein the positive electrode is an air electrode, whereby the zinc secondary battery forms a zinc-air secondary battery.

### BRIEF DESCRIPTION OF THE DRAWINGS

FIG. 1 is a SEM image of PTFE extracted from the negative electrode fabricated in Example 5, with a fiber portion marked with a pair of arrows indicating a fiber diameter measurement location.

FIG. 2 is a SEM image of PTFE extracted from the negative electrode fabricated in Example 9, with a fiber portion marked with a pair of arrows indicating a fiber diameter measurement location.

FIG. 3 is a SEM image of PTFE extracted from the negative electrode fabricated in Example 1 (comparison), with a fiber portion marked with a pair of arrows indicating a fiber diameter measurement location.

FIG. 4 is a SEM image of PTFE extracted from the negative electrode fabricated in Example 13 (comparison), with a fiber portion marked with a pair of arrows indicating a fiber diameter measurement location.

### DETAILED DESCRIPTION OF THE INVENTION

### Negative Electrode

The negative electrode of the present invention is a negative electrode used in zinc secondary batteries. This negative electrode includes a negative electrode active material and a binder. The negative electrode active material contains ZnO particles and Zn particles. The binder is a mixture of binder particles and binder fibers. The binder particle is composed of a binder resin and has a particulate form. The binder fiber is composed of the binder resin and has a fibrous form. In an image analysis of the negative electrode, the average fiber diameter of the binder fibers is 0.05 to 0.17 μm. In addition, in an image analysis of the negative electrode, a fiberization ratio, which is a ratio of an area of the binder fibers to the total area of the binder particles and the binder fibers, is 20 to 70%. Thus, fiberizing the binder resin added to the negative electrode at a predetermined proportion and controlling the average fiber diameter of the fiberized binder resin within a predetermined range allows a cycle life of a zinc secondary battery to be prolonged.

As described above, in conventional negative electrodes, as zinc repeatedly dissolves and precipitates by repeated charge/discharge, the negative electrode changes its morphology, causing high resistance due to clogging of pores and a decrease in a charge active material due to accumulation of isolated zinc, which results in difficulty in charge and discharge. Such problems can be effectively minimized or solved according to the negative electrode of the present invention. The mechanism is not necessarily clear, however, it is considered because the shape of the negative electrode is firmly retained by binding force of the binder fibers, so that the morphological change of the zinc negative electrode is inhibited.

The average fiber diameter of the binder fibers is 0.05 to 0.17 μm, preferably 0.08 to 0.17 μm, more preferably 0.10 to 0.17 μm, and further preferably 0.10 to 0.15 μm. In this manner, the shape of the negative electrode can be firmly retained while development of cracks and difficulty in controlling thickness and the like due to excessively high binding force of the binder fibers, are inhibited, so that the morphological change of the zinc negative electrode can be effectively inhibited. Measurement of the average fiber diameter can preferably be made according to the procedure shown in Example Evaluation 1 below.

The fiberization ratio of the binder is 20 to 70%, preferably 30 to 70%, more preferably from 40 to 70%, further preferably 50 to 70%, and particularly preferably 50 to 65%. In such a manner, the shape of the negative electrode can be firmly retained while development of cracks and difficulty in controlling thickness and the like due to excessively high binding force of the binder fibers, are inhibited, so that the morphological change of the zinc negative electrode can be effectively inhibited. The fiberization ratio of the binder is a proportion of area of the binder fibers to the total area of the binder particles and binder fibers in an image analysis of the negative electrode, and can be preferably calculated according to the procedure shown in Example Evaluation 1 below.

The content of binder fibers in the negative electrode is preferably 0.05 to 2 parts by weight, more preferably 0.1 to 2 parts by weight, more preferably 0.5 to 2 parts by weight, and particularly preferably 1 to 2 parts by weight, based on the content of the ZnO particles being 100 parts by weight. In this manner, the morphological change of the zinc negative electrode can be more effectively inhibited. The content of binder fibers can preferably be calculated according to the procedure shown in Example Evaluation 1 below.

The binder particle that is various resin particles commercially available for binders can be used, and is not particularly limited. The average particle diameter D50 of binder particles is not particularly limited, and is typically 0.01 to 2 μm and more typically 0.05 to 1 μm. In the present description, it is noted that the average particle diameter D50 used herein shall refer to a particle diameter at which the integrated volume from the small particle diameter side reaches 50% in a particle size distribution obtained by a laser diffraction and scattering method. The content of binder in the negative electrode (i.e., the total content of binder particles and binder fibers) is preferably 0.07 to 10 parts by weight and more preferably 0.3 to 7 parts by weight, based on the content of the ZnO particles being 100 parts by weight.

From the viewpoint of partially fiberizing the binder resin, it is preferably at least one selected from the group consisting of polytetrafluoroethylene (PTFE), polyvinylidene fluoride (PVDF), and a cellulose resin (for example, an acetyl cellulose resin), and more preferably PTFE. The binder resin composed of the binder particles and the binder resin composed of the binder fibers are preferably the same type of resin.

A method for forming a negative electrode containing a mixture of the binder particles and binder fibers is not particularly limited, and for example, the negative electrode can preferably be formed as follows. First, mixed powder containing ZnO particles, Zn particles, and the binder particles (for example, PTFE particles) is fabricated. Then, the mixed powder is kneaded together with a solvent (for example, propylene glycol or isopropyl alcohol) by applying a predetermined shear pressure and heating them to a predetermined temperature. At this time, the shear pressure is preferably 1 to 5 MPa and more preferably 2 to 5 MPa. A heating temperature is also preferably 20 to 60° C. and more preferably 40 to 60° C. In this manner, the binder particles are fiberized at a predetermined proportion, facilitating obtaining the binder fibers with the predetermined average fiber diameter described above. Thereafter, the kneaded product is made into a sheet, attached to a current collector, and dried to remove a solvent. Thus, a negative electrode containing the mixture of the binder particles and binder fibers can be obtained.

Negative electrode active material contains Zn particles and ZnO particles. The Zn particles are typically metallic Zn particles, however, Zn alloys or particles of a Zn compound may also be used. Metallic Zn particles that are commonly used in zinc secondary batteries can be used, however, smaller metal Zn particles are more preferably used from the standpoint of prolonging the cycle life of the battery. Specifically, the average particle diameter D50 of the metallic Zn particles is preferably 5 to 200 μm, more preferably 50 to 200 μm, and still more preferably 70 to 160 μm. The preferred content of Zn particles in negative electrode is preferably 1.0 to 87.5 parts by weight, more preferably 3.0 to 70.0 parts by weight, and still more preferably 5.0 to 55.0 parts by weight, based on the content of ZnO particles being 100 parts by weight. The metallic Zn particle may be doped with dopants such as In and Bi. The ZnO particles are not particularly restricted provided that commercially available zinc oxide powder used for a zinc secondary battery or zinc oxide powder obtained by growing particles by a solid phase reaction, etc., by using these powders as starting materials, may be used. The average particle diameter D50 of the ZnO particles is preferably 0.1 to 20 μm, more preferably 0.1 to 10 μm, and still more preferably 0.1 to 5 μm.

Preferably negative electrode further contains one or more metal elements selected from the group consisting of In and Bi. These metal elements can inhibit undesirable hydrogen gas from generating due to self-discharge of negative electrode. These metal elements may be contained in negative electrode in any form, such as metal, oxide, hydroxide, or other compounds, however, they are preferably contained in the form of oxide or hydroxide, more preferably in the form of oxide particles. The oxide of the metal element includes, for example, In₂O₃, Bi₂O₃, etc. The hydroxide of the metal element includes, for example, In(OH)₃, Bi(OH)₃, etc. In any case, preferably the content of In is 0 to 2 parts by weight in terms of oxide and the content of Bi is 0 to 6 parts by weight in terms of oxide, and more preferably the content of In is 0 to 1.5 parts by weight in terms of oxide and the content of Bi is 0 to 4.5 parts by weight in terms of oxide, based on the content of ZnO particles being 100 parts by weight. When In and/or Bi are contained in negative electrode in the form of oxide or hydroxide, not all of In and/or Bi need to be in the form of oxide or hydroxide, and they may be partially contained in the negative electrode in other forms such as metal or other compounds. For example, the above metal elements may be doped as trace elements in the metallic Zn particles. In this case, the concentration of In in the metallic Zn particles is preferably 50 to 2000 ppm by weight, more preferably 200 to 1500 ppm by weight, and the concentration of Bi in the metallic Zn particles is preferably 50 to 2000 ppm by weight and more preferably 100 to 1300 ppm by weight.

Negative electrode may further contain a conductive aid. Examples of the conductive aid include carbon, metal powders (tin, lead, copper, cobalt, and the like), and noble metal pastes.

The negative electrode is preferably a sheet-like pressed product. This enables preventing a negative electrode active material from falling off and improve an electrode density, thereby making it possible to inhibit change in the morphology of the negative electrode more effectively. Such a sheet-like pressed product can be fabricated by adding a binder to a negative electrode material followed by kneading, and pressing the obtained kneaded product by a roll press machine, etc., into a sheet.

The negative electrode is preferably provided with a current collector. Preferred examples of the current collector include a copper punching metal and a copper expanded metal. In this case, for example, a negative electrode plate composed of a negative electrode/current collector can be favorably fabricated by coating a surface of a copper punching metal or a copper expanded metal with a mixture containing Zn particles, ZnO particles, and the binder. At this time, the negative electrode plate (i.e., the negative electrode/current collector) after drying is also preferably subjected to press treatment to prevent the negative electrode active material from falling off and improve the electrode density. Alternatively, the sheet-like pressed product as described above may be compressed and bonded to a current collector such as a copper expanded metal.

### Zinc Secondary Battery

The negative electrode of the present invention is preferably applied to a zinc secondary battery. Therefore, according to a preferred embodiment of the present invention, a zinc secondary battery comprising a positive electrode, a negative electrode, a separator separating the positive electrode from the negative electrode so as to be capable of conducting hydroxide ions therethrough, and an electrolytic solution, is provided. The zinc secondary battery of the present invention is not particularly limited provided that it is a secondary battery in which negative electrode described above is used and an electrolytic solution (typically an aqueous alkali metal hydroxide solution) is used. Therefore, it can be a nickel-zinc secondary battery, a silver oxide-zinc secondary battery, a manganese oxide-zinc secondary battery, a zinc-air secondary battery, or various other alkaline-zinc secondary batteries. For example, a positive electrode preferably comprises nickel hydroxide and/or nickel oxyhydroxide, whereby the zinc secondary battery forms a nickel-zinc secondary battery. Alternatively, the positive electrode may be an air electrode, whereby the zinc secondary battery forms a zinc-air secondary battery.

The separator is preferably a layered double hydroxide (LDH) separator. As described above, LDH separators have been known in the field of nickel-zinc secondary batteries or zinc-air secondary batteries (see Patent Literatures 1 to 3), and an LDH separator can also be preferably used for the zinc secondary battery of the present invention. The LDH separator can prevent the penetration of zinc dendrites while selectively allowing hydroxide ions to permeate. Combined with the effect of adopting the negative electrode of the present invention, the durability of the zinc secondary battery can be further improved. Incidentally, the LDH separator herein is defined as a separator including a layered double hydroxide (LDH) and/or an LDH-like compound (hereinafter collectively referred to as a hydroxide ion-conducting layered compound), which selectively passes hydroxide ions by exclusively utilizing hydroxide ion conductivity of the hydroxide ion-conducting layered compound. The “LDH-like compound” herein, although it may not be called an LDH, is hydroxide and/or oxide with a layered crystal structure analogous to LDH, and can be considered as an equivalent of LDH. In a broader definition, however, “LDH” can also be interpreted to include not only LDH but also the LDH-like compound.

The LDH separator may be composited with porous substrates as disclosed in Patent Literatures 1 to 3. The porous substrate may be composed of any of ceramic materials, metallic materials, and polymer materials; however, it is particularly preferably composed of the polymer materials. The polymer porous substrate has advantages of 1) flexibility (hence, it is hard to break even if being thin.), 2) facilitation of increase in porosity, 3) facilitation of an increase in conductivity (because it can be rendered thin while increasing porosity.), and 4) facilitation of manufacture and handling. The polymer material is particularly preferably polyolefins such as polypropylene, polyethylene, etc., and most preferably polypropylene, in terms of excellent hot-water resistance, excellent acid resistance and excellent alkali resistance as well as low cost. When the porous substrate is composed of the polymer material, a hydroxide ion-conducting layered compound is particularly preferably incorporated over the entire region of the thickness direction of the porous substrate (for example, most or almost all the pores inside the porous substrate are filled with the hydroxide ion-conducting layered compound.). In this case, the thickness of the polymer porous substrate is preferably 5 to 200 μm, more preferably 5 to 100 μm, and still more preferably 5 to 30 μm. A microporous membrane that is commercially available as a separator for lithium batteries can be preferably used as such polymer porous substrates.

The electrolytic solution preferably comprises an alkali metal hydroxide aqueous solution. The alkali metal hydroxide includes, for example, potassium hydroxide, sodium hydroxide, lithium hydroxide, ammonium hydroxide, etc., however, potassium hydroxide is more preferred. Zinc oxide, zinc hydroxide, etc., may be added to the electrolytic solution in order to inhibit spontaneous dissolution of the zinc-containing material.

### LDH-Like Compound

According to a preferred aspect of the present invention, the LDH separator can be such that it contains an LDH-like compound; the definition of the LDH-like compound is as described above. A preferred LDH-like compound is as follows:
(a) Hydroxide and/or oxide with a layered crystal structure containing Mg and one or more elements with at least Ti, selected from the group consisting of Ti, Y, and Al; or
(b) hydroxide and/or oxide with a layered crystal structure containing (i) Ti, Y, and optionally Al and/or Mg and (ii) an additive element M that is at least one type selected from the group consisting of In, Bi, Ca, Sr and Ba; or
(c) hydroxide and/or oxide with a layered crystal structure containing Mg, Ti, Y, and optionally Al and/or In, wherein the LDH-like compound is present in the form of a mixture with In(OH)₃ in (c).

According to the preferred aspect (a) of the present invention, the LDH-like compound can be hydroxide and/or oxide with a layered crystal structure containing Mg and one or more elements with at least Ti, selected from the group consisting of Ti, Y, and Al. Thus, a typical LDH-like compound is complex hydroxide and/or complex oxide of Mg, Ti, optionally Y, and optionally Al. The aforementioned elements may be replaced by other elements or ions to the extent that the basic characteristics of the LDH-like compound are not impaired; however, the LDH-like compound is preferably free of Ni. For example, the LDH-like compound may be such that it further contains Zn and/or K. This can further improve the ionic conductivity of the LDH separator.

The LDH-like compound can be identified by X-ray diffraction. Specifically, when an LDH separator undergoes X-ray diffraction on its surface, a peak derived from the LDH-like compound is typically detected in the range of 5°≤2θ≤10° and more typically in the range of 7°≤2θ≤10°. As described above, LDH is a substance with an alternating stacked structure in which exchangeable anions and H₂O are present as an intermediate layer between the stacked hydroxide base layers. In this regard, when an LDH is measured by an X-ray diffraction method, a peak (i.e., the (003) peak of LDH) is essentially detected at the position of 2θ=11 to 12° derived from a crystal structure of LDH. When the LDH-like compound is measured by the X-ray diffraction method, on the contrary, a peak is typically detected in the range described above that is shifted to the lower angle side than the position of the aforementioned peak of LDH. Moreover, using the 2θ corresponding to the peak derived from the LDH-like compound in the X-ray diffraction enables determination of the interlayer distance of the layered crystal structure according to the Bragg formula. The interlayer distance of the layered crystal structure constituting the LDH-like compound determined in such a way is typically 0.883 to 1.8 nm and more typically 0.883 to 1.3 nm.

The LDH separator according to the aspect (a) above has an atomic ratio of Mg/(Mg+Ti+Y+Al) in the LDH-like compound of preferably 0.03 to 0.25 and more preferably 0.05 to 0.2, as determined by energy dispersive X-ray spectroscopy (EDS). Further, the atomic ratio of Ti/(Mg+Ti+Y+Al) in the LDH-like compound is preferably 0.40 to 0.97 and more preferably 0.47 to 0.94. Furthermore, the atomic ratio of Y/(Mg+Ti+Y+Al) in the LDH-like compound is preferably 0 to 0.45 and more preferably 0 to 0.37. In addition, the atomic ratio of Al/(Mg+Ti+Y+Al) in the LDH-like compound is preferably 0 to 0.05 and more preferably 0 to 0.03. The ratios within the above ranges render alkali resistance more excellent and make it possible to more effectively achieve an inhibition effect of short circuits caused by zinc dendrites (i.e., dendrite resistance). By the way, an LDH, which has been conventionally known for an LDH separator, can be represented by the basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to another preferred aspect (b) of the present invention, the LDH-like compound can be hydroxide and/or oxide with a layered crystal structure containing (i) Ti, Y, and optionally Al and/or Mg, and (ii) additive element M. Thus, a typical LDH-like compound is complex hydroxide and/or complex oxide of Ti, Y, additive element M, optionally Al, and optionally Mg. Additive element M is In, Bi, Ca, Sr, Ba or combinations thereof. The above elements may be replaced by other elements or ions to the extent that the basic characteristics of the LDH-like compound are not impaired; however, the LDH-like compound is preferably free of Ni.

The LDH separator according to the aspect (b) above preferably has an atomic ratio of Ti/(Mg+Al+Ti+Y+M) in the LDH-like compound of 0.50 to 0.85 and more preferably 0.56 to 0.81, as determined by energy dispersive X-ray spectroscopy (EDS). The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. In addition, the atomic ratio of Al/(Mg+Al+Ti+Y+M) in the LDH-like compound is preferably 0 to 0.05 and more preferably 0 to 0.04. The ratios within the above ranges render the alkali resistance more excellent and make it possible to more effectively achieve an inhibition effect of short circuits caused by zinc dendrites (i.e., dendrite resistance). By the way, an LDH, which has been conventionally known regarding a LDH separator, can be represented by a basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to yet another preferred aspect (c) of the present invention, the LDH-like compound can be hydroxide and/or oxide with a layered crystal structure containing Mg, Ti, Y, and optionally Al and/or In, wherein the LDH-like compound is present in the form of a mixture with In(OH)₃. The LDH-like compound of this aspect is hydroxide and/or oxide with a layered crystal structure containing Mg, Ti, Y, and optionally Al and/or In. Thus, a typical LDH-like compound is complex hydroxide and/or complex oxide of Mg, Ti, Y, optionally Al, and optionally In. It is to be noted that In that can be contained in the LDH-like compound may be not only In that is intended to be added to the LDH-like compound, but also In that is unavoidably incorporated into the LDH-like compound derived from the formation of In(OH)₃, or the like. The above elements can be replaced by other elements or ions to the extent that the basic characteristics of the LDH-like compound are not impaired; however, the LDH-like compound is preferably free of Ni. By the way, an LDH, which has been conventionally known regarding a LDH separator, can be represented by a basic composition with the general formula: M²⁺₁₋ₓM³⁺ₓ(OH)₂Aⁿ⁻_{x/n}·mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of a conventional LDH.

The mixture according to the aforementioned aspect (c) contains not only the LDH-like compound but also In(OH)₃ (typically composed of the LDH-like compound and In(OH)₃). Containing In(OH)₃ in the mixture enables effective improvement in the alkali resistance and dendrite resistance of an LDH separator. The content proportion of In(OH)₃ in the mixture is preferably an amount that can improve the alkali resistance and dendrite resistance without impairing hydroxide ion conductivity of an LDH separator, and is not particularly limited. In(OH)₃ may be such that it has a cubic crystalline structure and also has a configuration in which the crystalline of In(OH)₃ is surrounded by the LDH-like compound. The In(OH)₃ can be identified by X-ray diffraction.

### EXAMPLES

The present invention will be described in more detail with reference to the following Examples.

### Examples 1 to 13

### (1) Preparation of Positive Electrode

A paste-type nickel hydroxide positive electrode (capacity density: about 700 mAh/cm³) was prepared.

### (2) Fabrication of Negative Electrode

Various raw material powders shown below were prepared.
ZnO powder (manufactured by Seido Chemical Industry Co., Ltd., JIS Standard Class 1 grade, average particle size D50: 0.2 μm)
Metallic Zn powder (doped with Bi and In, Bi: 70 ppm by weight, In: 200 ppm by weight, average particle diameter D50: 120 μm, manufactured by Dowa Electronics Materials Co., Ltd.)
PTFE particles (manufactured by Daikin Industries, Ltd., Product No: D-210C, average particle diameter D50: 0.25 μm)

To 100 parts by weight of ZnO powder were added 5.7 parts by weight of metallic Zn powder and PTFE particles as a binder resin in the proportion compounded shown in Table 1, and the mixture was heated and kneaded together with propylene glycol to obtain a kneaded product in which the PTFE particles were partially fiberized. In this case, the binder fibers were regulated for their fiberization ratios and diameters by appropriately changing the shear pressure and heating temperature as shown in Table 1. The obtained kneaded product was rolled by a roll press to obtain a negative electrode active material sheet. The negative electrode active material sheet was compressed and adhered to a tin-plated copper expanded metal to obtain a negative electrode.

### (3) Preparation of Electrolytic Solution

Ion-exchanged water was added to a 48% potassium hydroxide aqueous solution (manufactured by Kanto Chemical Co., Inc., special grade) to adjust the KOH concentration to 5.4 mol %, and then zinc oxide was dissolved at 0.42 mol/L by heating and stirring to obtain an electrolytic solution.

### (4) Fabrication of Evaluation Cell

The positive electrode and the negative electrode were each wrapped with a nonwoven fabric, and each welded with a current extraction terminal. The positive electrode and the negative electrode thus fabricated were opposed to each other with the LDH separator interposed therebetween, sandwiched by a laminated film provided with a current extraction port, and the laminated film was heat-sealed on three sides thereof. The electrolytic solution was added to the obtained cell container with the upper side being opened, and was sufficiently permeated into the positive electrode and the negative electrode by vacuum evacuation, etc. Thereafter the remaining one side of the laminated film was also heat-sealed to form a simply sealed cell.

### (5) Evaluation

### Evaluation 1: Negative Electrode Observation

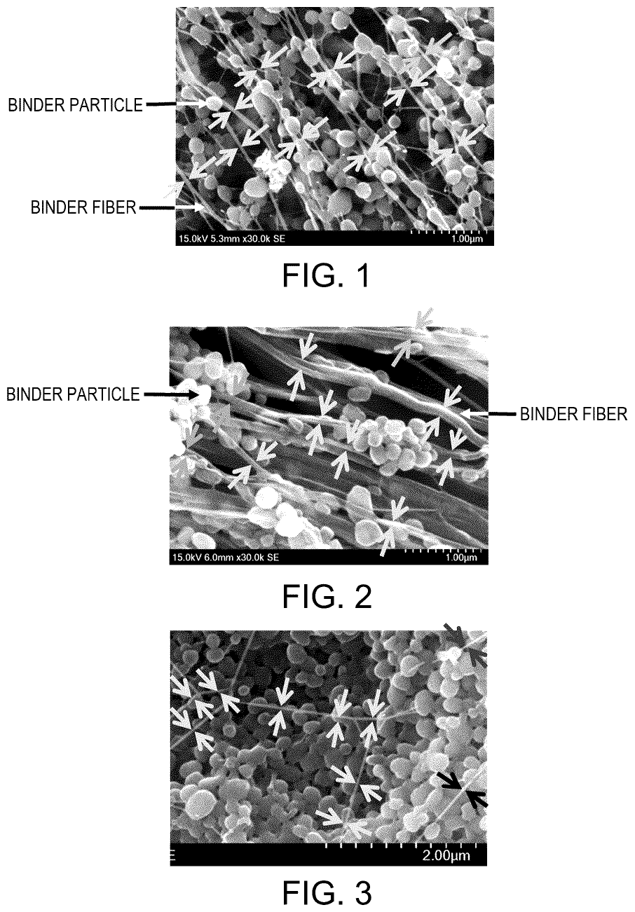

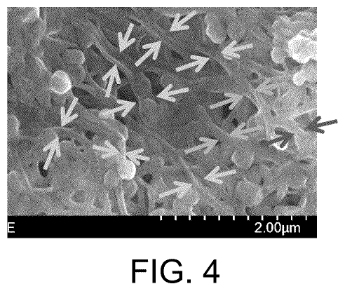

Each negative electrode of Examples 1 to 13 was immersed in the electrolytic solution prepared in (3) above to dissolve the ZnO particles and Zn particles, and then the extracted PTFE was observed with a field emission scanning electron microscope (FE-SEM, S-4800, manufactured by Hitachi High-Tech Corporation) at a magnification of 30,000 times in a 3 μm×4 μm field of view. SEM images acquired in Example 5, Example 9, Example 1 (comparison) and Example 13 (comparison) are shown in FIGS. 1 to 4, respectively. The acquired SEM images were imported into image processing software (Adobe Illustrator, manufactured by Adobe, Inc). Then, the fiber diameters of a binder fiber was measured at 10 locations as shown in FIGS. 1 to 4, and the average value thereof was used as an average fiber diameter. The results are shown in Table 1.

Next, with the above image processing software, a proportion of area occupied by the binder fibers in the total field of view of the SEM image (fiberized area ratio A₁) and a proportion of area occupied by the binder particles in the total field of view of the SEM image (particulate area ratio A₂) were determined. Then, the fiberization ratio of the binder resin was calculated according to the following formula:

[A₁/(A₁+A₂)]×100

For example, in Example 5, the fiberized area ratio A₁ was 11% and the particulate area ratio A₂ was 44%, so the fiberization ratio was calculated to be 20% according to the above formula. The product of the amount of binder resin added and the fiberization ratio of the binder resin was used to determine the content of the binder fibers based on the content of the ZnO particles being 100 parts by weight. The results are as shown in Table 1.

### Evaluation 2: Cycle Characteristics

Chemical conversion was carried out on the simply sealed cell with 0.1C charge and 0.2C discharge by using a charge/discharge apparatus (TOSCAT3100 manufactured by Toyo System Co., Ltd.). Then, a 1C charge/discharge cycle was carried out. Repeated charge/discharge cycles were carried out under the same conditions, and the number of charge/discharge cycles until a discharging capacity decreased to 70% of the discharging capacity of the first cycle of the prototype battery was recorded, the procedure of which was adopted as an indicator of cycle characteristics. The results are as shown in Table 1, confirming that the fiberization of the binder resin in the predetermined proportion and the binder fibers having a predetermined average fiber diameter improve the cycle characteristics. It is noted that in Example 1 (comparison), the binding force of the binder resin was low and the negative electrode shape could not be retained, as a result of which the cycle characteristic evaluation could not be made. In addition, in Examples 11 to 13 (comparison), the binding force of the binder resin was excessive, cracks occurred, and it was difficult to control the thickness of the negative electrode, thereby making it impossible to make the cycle characteristics evaluation.

TABLE 1

| | | | | Evaluation | | | |
|---|---|---|---|---|---|---|---|
| | Fabrication conditions of negative electrode | | | Binder resin | | | |
| | Amount of binder | | | | | Content of binder | |
| | resin added relative to | Heating and kneading | | | | fibers relative to | |
| | 100 parts by weight | Shear | Heating | Fiber | Fiberization | 100 parts by weight | |
| | of ZnO particles | pressure | temperature | diameter | ratio | of ZnO particles | Cycle |
| | (parts by weight) | (MPa) | (° C.) | (μm) | (%) | (parts by weight) | characteristics |
| Example 1* | 1.7 | 0.5 | 15 | 0.02 | 3 | 0.05 | — |
| Example 2* | 0.40 | 0.5 | 20 | 0.02 | 20 | 0.08 | 100 |
| Example 3* | 0.53 | 1 | 15 | 0.05 | 15 | 0.08 | 150 |
| Example 4 | 0.10 | 1 | 20 | 0.05 | 20 | 0.02 | 350 |
| Example 5 | 0.25 | 1 | 40 | 0.05 | 20 | 0.05 | 600 |
| Example 6 | 3.3 | 2 | 40 | 0.05 | 30 | 1 | 700 |
| Example 7 | 3.3 | 3 | 40 | 0.08 | 30 | 1 | 800 |
| Example 8 | 2.0 | 3 | 60 | 0.08 | 50 | 1 | 900 |
| Example 9 | 2.9 | 5 | 60 | 0.17 | 70 | 2 | 1100 |
| Example 10 | 4.3 | 5 | 60 | 0.17 | 70 | 3 | 400 |
| Example 11* | 2.5 | 5 | 70 | 0.17 | 80 | 2 | — |
| Example 12* | 4.3 | 7 | 60 | 0.24 | 70 | 3 | — |
| Example 13* | 3.2 | 7 | 70 | 0.24 | 95 | 3 | — |

*denotes Comparative Example

What is claimed is:

1. A negative electrode for use in a zinc secondary battery, comprising:
a negative electrode active material comprising ZnO particles and Zn particles, and
a binder that is a mixture of binder particles composed of a binder resin and binder fibers composed of the binder resin,
wherein, in an image analysis of the negative electrode, an average fiber diameter of the binder fibers is 0.05 to 0.17 μm, and a fiberization ratio, which is a ratio of an area of the binder fibers to the total area of the binder particles and the binder fibers, is 20 to 70%.

2. The negative electrode according to claim 1, wherein the content of the binder fibers is 0.05 to 2 parts by weight, based on the content of ZnO particles being 100 parts by weight.

3. The negative electrode according to claim 1, wherein the binder resin is at least one selected from the group consisting of polytetrafluoroethylene (PTFE), polyvinylidene fluoride (PVDF), and a cellulose resin.

4. The negative electrode according to claim 1, comprising the Zn particles in an amount of 1.0 to 87.5 parts by weight, based on the content of the ZnO particles being 100 parts by weight.

5. The negative electrode according to claim 1, further comprising one or more metal elements selected from In and Bi.

6. The negative electrode according to claim 1, wherein the negative electrode is a sheet-like pressed product.

7. A zinc secondary battery, comprising:
a positive electrode,
the negative electrode according to claim 1,
a separator separating the positive electrode from the negative electrode so as to be capable of conducting hydroxide ions therethrough, and
an electrolytic solution.

8. The zinc secondary battery according to claim 7, wherein the separator is an LDH separator comprising a layered double hydroxide (LDH) and/or an LDH-like compound.

9. The zinc secondary battery according to claim 8, wherein the LDH separator is composited with a porous substrate.

10. The zinc secondary battery according to claim 7, wherein the positive electrode comprises nickel hydroxide and/or nickel oxyhydroxide, whereby the zinc secondary battery forms a nickel-zinc secondary battery.

11. The zinc secondary battery according to claim 7, wherein the positive electrode is an air electrode, whereby the zinc secondary battery forms a zinc-air secondary battery.
